(19) United States
(12) Patent Application Publication
(10) Pub. No.: US 2003/0152731 A1
(43) Pub. Date: Aug. 14, 2003

(54) Self-adhesive magnet receptive surface covering

(76) Inventors: Dayton J. Deetz, Mendon, MA (US); Sandra L. Deetz, Mendon, MA (US); John Willwerth, Bloomfield, MI (US); Paul Stefanuti, Bloomfield Village, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/072,454

(22) Filed: Feb. 8, 2002

(51) Int. Cl. B32B 9/00

(52) U.S. Cl. 428/40.1

(57) ABSTRACT

A magnet receptive surface covering comprises a nonferrous layer and a layer of ferromagnetic particles applied to the nonferrous layer. An adhesive layer is applied to the nonferrous layer. A cover sheet may cover the adhesive until the magnet receptive surface is to be applied to a surface, such as a wall.

### BACKGROUND OF THE INVENTION

The present invention relates to a magnetic surface covering that may be mounted to a surface such as a wall.

Magnetic boards exist that may be mounted to a surface such as a wall that create a magnetically attractive surface for magnets. Such surfaces are useful for educational and entertainment purposes. Typically, these boards are made of a steel sheet and may serve the dual function of acting as a magnet board and a chalkboard.

Existing magnetic boards are frequently heavy, cumbersome and rigid because steel sheets are used to provide the magnetically interactive surface. Thus, such boards are frequently difficult to transport and are often mounted permanently to the wall as a fixture. The inconvenience of these boards precludes their wider use.

Another manner of providing a magnetically attractive surface is to apply a magnetic paint on the surface. However, painting a wall with magnetic paint is time consuming. Like the magnetic board, such a surface is also difficult to remove once applied. The surface with the magnetic paint is left permanently on the wall after its use. A magnetic paint also fails to offer the convenience of transportability of the magnetic surface.

Magnetic surfaces also exist wherein ferrous material is mixed together with a plastic to form a compound, which may be formed into a rubbery sheet. While the sheet is easier to transport than steel sheets, it is still relatively heavy. Moreover, the plastic makes the sheet difficult to cut, limiting its utility.

A need therefore exists for a magnetic surface covering that maybe easily installed, removed and transported.

### SUMMARY OF THE INVENTION

The present invention comprises a magnet receptive surface covering having as its base layer a nonferrous substrate. Ferromagnetic particles are applied to the substrate to provide a magnetically interactive surface. The nonferrous layer may be a flexible substrate, such as paper. The use of particles rather than a steel sheet allows the nonferrous substrate to retain its flexibility and avoids adding significant weight to the substrate. A binding agent, such as a latex, may be sued to bind the iron particles to the nonferrous substrate.

To permit the quick mounting of the substrate on a surface, such as a wall, an adhesive layer may be applied to the substrate. A removable coversheet covers the adhesive and permit the “peel and stick” application of the covering on wall. The magnet receptive covering may have a border to permit the surface covering to be easily peeled away from the coversheet. In addition, a pressure sensitive adhesive may be used so that the surface covering, once peeled away from the coversheet may be press applied to the wall.

Moreover, the nonferrous substrate with a ferrous particle layer may have a polymer layer. The polymer layer provides a protective coating over the substrate and permits the use of markers, such as dry erase markers, on the surface of the covering without permanent marking. The polymer layer also creates a stain resistant surface.

The invention may include magnetic pieces that interact with the surface covering. A design may be placed on the nonferrous substrate, providing an interactive scene, such as a dollhouse, on which the magnet play pieces and dry erase markers may be used. Thus, an individual using the inventive magnetic surface covering may peel and stick the covering to a wall, thereby quickly and conveniently creating a magnet attracting surface on which magnets and markers may be used for both educational and entertainment purposes. Moreover, the magnetic surface may also be peeled from the wall following its use. Because of the flexibility of the wall covering, the covering may be easily transported to and from any surface on which it may be desirable to create an interactive magnetic and dry erase surface.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates the invention, showing nonferrous layer, a layer of ferromagnetic particles, an adhesive layer, and a coversheet.

FIG. 2 illustrates the magnetic surface covering of FIG. 1 including a polymer layer.

FIG. 3 illustrates an interactive play scene with a magnetic piece.

FIG. 4 illustrates the invention placed on a surface of a wall.

### DETAILED DESCRIPTION OF THE PREFERRED EMBODIMENT

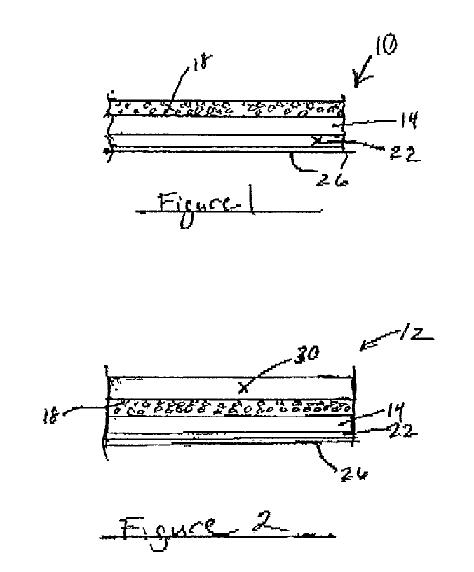

FIG. 1 illustrates an inventive magnet receptive surface covering 10. Surface covering 10 comprises nonferrous layer 14, on which is applied a layer of ferromagnetic particles 18. Nonferrous layer 14 may comprise a flexible substrate. Paper, non-woven plastic, needled felt, or other material may be used as the substrate, depending upon the particular needs of the application. In contrast to a steel sheet, the use of ferromagnetic particles on such substrates allows for the creation of a flexible, lightweight, and inexpensive magnet receptive surface covering.

The ferromagnetic particles may be applied to nonferrous layer 14 as taught by U.S. Pat. Nos. 5,609,788 and 5,843,329. These patents are hereby incorporated into this disclosure by reference. The ferromagnetic particles may also be formed on nonferrous layer 14 in the form of a coating, which is applied through known coating techniques, such as a knife over roll technique, to nonferrous layer 14. Layer of ferromagnetic particles 18 may be from 1 to 15 mils thickness having a 50% to 90% iron solids per weight content. Nonferrous layer 14 maybe ½ to 100 mils thickness. A binding agent, such as a latex, may be used with ferromagnetic particles to create layer of ferromagnetic particles 18 and bind this layer to nonferrous layer 14.

To promote the quick and convenient installation of magnet responsive surface covering on a surface, adhesive layer 22 may be applied to nonferrous substrate 14. Adhesive layer 22 may comprises a pressure sensitive adhesive that permits covering 10 to be press applied to the surface once coversheet 26 is removed from adhesive layer 22. Such an adhesive may depend on the particular requirements of the enduser. Adhesive layer 22 may also be removable from the surface following its application and to allow nonferrous layer 14 to be reapplied to another surface. Preferably, an adhesive such as a GEL-TAC® 142E-2000 adhesive or any other commercially available acrylic polymer microsphere adhesive with adhesive sphere sizes range from 10 to 80 microns in diameter may be used to leave no or little adhesive residue on the surface. Adhesive layer 22 may be a ½ once to 2 ounces per square foot.

Cover sheet 26 may cover adhesive layer 22 to permit the “peel and stick” application of covering 10 on a wall or other surface. Cover sheet 26 may comprise a paper with a coating, such as a polyethylene coating, to permit cover sheet 26 to be removed from adhesive layer 22 without removing a significant amount of adhesive layer 22. Thus, following removal, cover sheet 26 allows nonferrous layer 14 to retain enough adhesive layer 22 to allow covering 10 to stick to the surface.

While FIG. 1 illustrates adhesive layer 22 on one side of nonferrous layer 14 and layer of ferromagnetic particles 18 on the other, the order of layering may be varied to accomplish the same objective of providing a magnet receptive surface that may be quickly and easily adhered to a surface. For example, adhesive layer 22 may be applied to nonferrous substrate 14 on the same side as ferromagnetic particles 18. Other layers may be introduced between these layers.

FIG. 2 illustrates another aspect of the invention. Magnet receptive surface covering 12 comprises nonferrous substrate 14 with layer of ferromagnetic particles 18 and adhesive 22 applied to covering 12. As explained above, coversheet 26 may covers adhesive 22. In addition, covering 12 may comprise layer 30, which may be a polymer, such as a polypropylene laminate, which may be a film laminate that is heat applied as known. Preferably, the polymer is marker resistant so as to permit a marker to mark layer 30 and permit the marking to be removed such as through a dry eraser. A polypropylene laminate will accomplish this function.

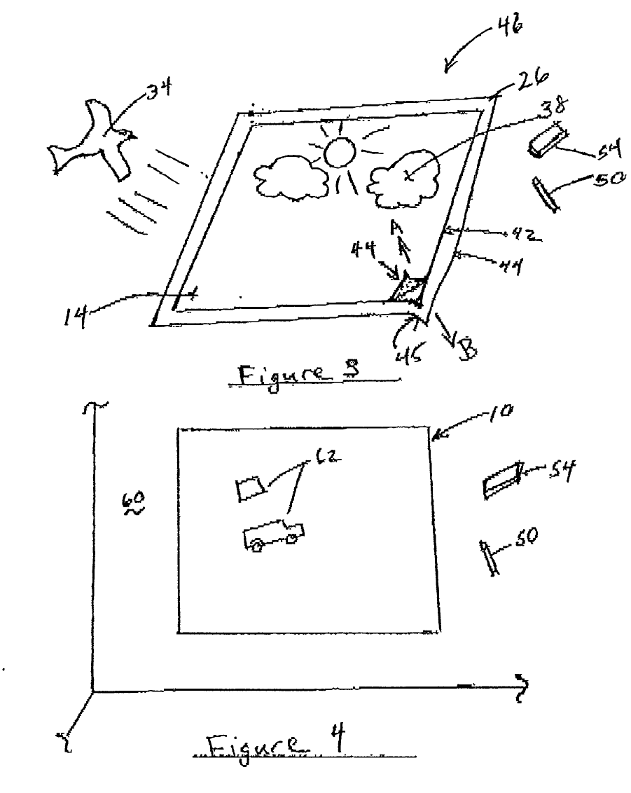

FIG. 3 illustrates magnetic surface covering 46, which incorporates design 38. Design 38 may depict a variety of scenes or illustrations to promote the interactive nature of the invention. Here, magnetic piece 34, a play piece, is shown providing a magnet that may interact with a ferromagnetic particle of magnetic surface covering 46. Marker 50 and dry eraser 54 are also shown. Magnetic piece 34 may be consistent with the thematic content of design 38.

FIG. 3 also illustrates the use of a border to facilitate the removal of nonferrous substrate 14 from coversheet 26. Thus, nonferrous substrate may have periphery 42, which consists of a cut or perforated perimeter that permits the peeling away of leaf 44 of nonferrous layer 14 from coversheet 26 as well as the remainder of nonferrous layer 14 within periphery 42. Periphery 44 is also provided so as to create a tab between periphery 42 and periphery 44 that allows leaf 44 to be peeled along arrow A and leaf 45 along arrow B. In this way, magnet receptive surface covering 46 may be peeled quickly away from coversheet 26 and placed on surface in a “peel and stick” manner.

FIG. 4 illustrates magnetic surface covering 10 placed on wall 60. Dry eraser 54 and marker 50 are also illustrated to show that a magnetic wall covering offers a dry erase surface for interaction as well as a magnetic surface covering. Magnets 62 are shown as placed on magnetic surface covering 10.

Although particular variations of magnetic surface coverage are shown, one of ordinary skill in the art can envision other ways to modify the invention that fall within the scope of this disclosure. The order of layers of ferromagnetic particles, adhesive layers, coversheets, polymer layers, latex layers, with respect to the nonferrous substrate may all be altered by rearranging the order which respect to the substrate. Moreover, the manner of combining these layers may also be altered and still fall within the scope of this invention.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A magnet receptive surface covering comprising:
a nonferrous layer;
a layer of ferromagnetic particles applied to said nonferrous layer;
an adhesive layer applied to said nonferrous layer; and
a cover sheet at least partially covering said adhesive and removable from said adhesive layer.

2. The magnet receptive surface covering of claim 1 wherein said nonferrous layer comprises a flexible substrate.

3. The magnet receptive surface covering of claim 1 wherein said adhesive comprises a pressure sensitive adhesive.

4. The magnet receptive surface covering of claim 1 including a polymer layer applied to said nonferrous layer.

5. The magnet receptive surface covering of claim 1 including a magnetic piece for interacting with said layer of ferromagnetic particles.

6. The magnet receptive surface covering of claim 1 including a design on said nonferrous layer.

7. The magnet receptive surface covering of claim 1 wherein said layer of ferromagnetic particles comprises ferromagnetic particles mixed with a binding agent that binds said layer to said nonferrous layer.

8. The magnet receptive surface covering of claim 1 wherein said nonferrous layer comprises a first periphery and said cover sheet comprises a second periphery wherein said first periphery is within said second periphery so as to form a border between said first periphery and said second periphery.

9. The magnet receptive surface covering of claim 1 wherein said nonferrous layer comprises a paper.

10. The magnet receptive surface covering of claim 1 wherein said nonferrous layer comprises a first side and a second side and wherein said layer of ferrous particles is applied on said first side and said adhesive layer is applied on said second side.

11. A magnet receptive surface covering comprising:
a nonferrous layer;
a layer of ferromagnetic particles applied to said nonferrous layer; and
a polymer layer applied to said nonferrous layer.

12. The magnet receptive surface covering of claim 11 including an adhesive layer.

13. The magnet receptive surface covering of claim 12 wherein said adhesive layer comprises a pressure sensitive adhesive.

14. The magnet receptive surface covering of claim 11 including a magnetic piece for interacting with said ferromagnetic particles.

15. The magnet receptive surface covering of claim 11 including a design on said nonferrous layer.

16. The magnet receptive surface covering of claim 11 wherein said nonferrous layer comprises a paper.

17. A magnet receptive surface covering comprising:
a nonferrous layer comprising a flexible substrate;
a layer of ferromagnetic particles applied to said nonferrous layer;
a pressure sensitive adhesive layer applied to said nonferrous layer;
a polymer layer applied to said nonferrous layer; and
a cover sheet at least partially covering said adhesive and removable from said adhesive layer.

18. The magnet receptive surface covering of claim 17 including a magnetic piece for interacting with said layer of ferromagnetic particles.

19. The magnet receptive surface covering of claim 17 including a design on said nonferrous layer.

20. The magnet receptive surface covering of claim 17 wherein said nonferrous layer comprises a first periphery and said cover sheet comprises a second periphery wherein said first periphery is within said second periphery so as to form a border between said first periphery and said second periphery.
